(19) United States
(12) Patent Application Publication
(10) Pub. No.: US 2026/0177097 A1
(43) Pub. Date: Jun. 25, 2026

(54) FASTENING DEVICE FOR CONNECTING A RAIL ELEMENT TO A STRUCTUAL ELEMENT OF A VEHICLE, AND RAIL ELEMENT

(71) Applicant: Adient US LLC, Plymouth, MI (US)

(72) Inventor: Erik SPRENGER, Wermelskirchen (DE)

(21) Appl. No.: 18/728,871

(22) PCT Filed: Jan. 19, 2023
(86) PCT No.: PCT/IB2023/050456

§ 371 Date: Jul. 13, 2024

(30) Foreign Application Priority Data
Jan. 21, 2022 (DE) 10 2022 200 686.0
May 5, 2022 (DE) 10 2022 204 449.5

(51) Int. Cl. F16B 37/08; B60N 2/02; B60N 2/07; B60N 2/08; B60N 2/22; B60N 2/68; F16B 5/02

(52) U.S. Cl. CPC F16B 37/0842; B60N 2/02246; B60N 2/0705; B60N 2/08; B60N 2/22; B60N 2/682; F16B 5/025

(57) ABSTRACT

A fastening device for a rail element of a longitudinal adjustment device may have at least one securing washer with a through-opening and a bolt with at least one external thread. The bolt is pre-fixed and held in the through-opening by self-locking. The securing washer has a first strength and the bolt has a second strength.

The invention relates to a fastening device for connecting a rail element to a structural element of a vehicle, and a rail element having such a fastening device.

Fastening devices of the type in question for connecting a rail element of an adjustment device for longitudinal adjustment of a vehicle seat are usually manufactured as a preassembled module, which are connected to a vehicle seat on one side and to a structural element of the vehicle, such as a vehicle floor, on the other side only during their final mounting.

The object of the present invention is to specify a fastening device of the type mentioned in the introduction that is preassemblable and prefixable and has improved strength. A rail element having an improved fastening device is also to be specified.

With regard to the fastening device, the object is achieved according to the invention by the features specified in claim 1. With regard to the rail element, the object is achieved according to the invention by the features specified in claim 14.

The object is achieved according to the invention with a fastening device that comprises at least one securing plate with a through-opening and a bolt with at least one external thread having multiple external thread flights, wherein the securing plate has a first strength and the bolt has a second strength, wherein for example the first strength is lower than the second strength, and wherein the bolt is prefixed and held in the through-opening by means of self-locking.

The securing plate can have at least one nose on an inner circumference of the through-opening to prefix the bolt. The at least one nose can protrude into the through-opening. The at least one nose can protrude or project from the inner circumference of the through-opening. The prefixing of the bolt can take place by self-locking of the bolt in the through-opening by means of the at least one nose. When the bolt and securing plate are joined, the nose can enter into a friction fit with the external thread flight or external thread flights of the bolt with interference. Owing to the lower strength of the securing plate, deformation of the nose can occur in the process, without damage to the bolt, in particular to the external thread. For example, a surface of the nose is smoothed. The interference of the nose is thereby reduced to an effective interference producing the friction fit.

The securing plate can have a plurality of noses, for example two noses, in particular three or more noses, on an inner circumference of the through-opening to prefix the bolt by means of self-locking. The noses are molded, in particular stamped, with a height offset from one another on the inner circumference of the through-opening. In the assembled state, the noses engage in the external thread flights of the bolt and are prefixed and held by means of a friction fit. For this purpose, the noses have for example larger dimensions than those of the external thread flights of the bolt. When the bolt and securing plate are joined, the noses thus enter into a friction fit with the external thread flights of the bolt with interference. Owing to the lower strength of the securing plate, deformation of the noses can occur in the process, without damage to the bolt, in particular to the external thread. For example, the surfaces of the noses are smoothed. The interference of the noses is thereby reduced to an effective interference producing the friction fit. In other words: Owing to the interference of the noses, plasticization and a friction fit connection between the bolt and the securing plate occur when the securing plate and the bolt are joined. The noses can be provided distributed, in particular molded or arranged, symmetrically around the inner circumference. For axially symmetrical prefixing of the bolt in the securing plate, there are preferably three noses provided, distributed symmetrically around the inner circumference of the through-opening. The securing plate can also have two mutually opposing noses. This arrangement of the bolt in the securing plate with three symmetrically distributed noses is also referred to as a three-point position of the bolt in the securing plate.

The securing plate can have an internal thread with an internal thread pitch on an inner circumference of the through-opening to prefix the bolt by means of self-locking. The bolt has at least one external thread with an external thread pitch. The internal thread pitch of the through-opening differs from the external thread pitch of the bolt. In other words: In the assembled state, the bolt is prefixed and held in the securing plate by the external thread and the internal thread by means of self-locking. For this purpose, the external thread pitch of the bolt is different from the internal thread pitch of the through-opening of the securing plate.

The securing plate can be designed as a shim. The securing plate can have a square or rectangular outer contour. The securing plate can have a comparatively small wall thickness, for example of 2 mm to 5 mm, wherein a strength can be achieved by quenching and tempering.

To prefasten the bolt or a screw, the securing plate can have a ring vulcanized into the through-opening. The ring can be formed for example from a rubber material, for example from so-called EPDM. The ring can be attached in the through-opening at least partially by a material bond.

Thanks to the prefastening of the bolt or the screw in the securing plate, further prefastening of the securing plate is not necessary. The securing plate can be guided in a channel and held in position with the bolt or the screw. The ring can be an annular sealing element. The bolt or the screw can enter into self-locking engagement, in particular a friction fit, with the ring in the through-opening when joined with the securing plate.

One exemplary embodiment provides for the securing plate or shim to comprise a recess, in particular an arcuate or angular recess, on the outer perimeter. For example, the recess on the outer perimeter can be made in the outer contour of the securing plate by stamping. The recess is a clearance, for example. The recess is punched into the outer contour of the securing plate or shim. The recess is in the form of an arc or angle. The recess is made for example by a stamp on a side facing a profile.

In addition, direction elements and/or marking elements such as direction protrusions and/or marking protrusions can be provided on the outer perimeter, in particular on a side perimeter.

One exemplary embodiment provides for the securing plate to have at least one direction element that protrudes from a surface side of the securing plate. The at least one direction element and/or marking element is provided to avoid incorrect installation of the securing plate or shim. The direction element and/or marking element are/is made in the securing plate or shim as a nose, in particular for a so-called poka-yoke measure. As a result, the securing plate or shim cannot be inserted the wrong way round into a guide channel of the rail element.

The object is achieved according to the invention with a rail element that comprises at least one profiled rail that is connectable to a structural element of a vehicle and has a bottom region with at least one mounting opening and two side walls protruding from the bottom region and one or more guide faces or guide tracks arranged on the inside of the side walls in the profiled rail, wherein the above-described fastening device is arrangeable in the rail element such that the securing plate lies with its through-opening over the mounting opening, and the bolt is arrangeable between the side walls, passing through the through-opening of the securing plate and engaging partially in the mounting opening of the profiled rail, in particular is prefixable and held in the through-opening of the securing plate, by means of self-locking.

The advantages achieved with the invention consist in particular in that such a fastening device for a rail element of a longitudinal adjuster can be mounted variably and safely. In addition, it allows a higher strength of the fastening device and thus of the connection of the rail element to a structural element of the vehicle.

Exemplary embodiments of the invention are explained in more detail with the aid of drawings. In the figures:

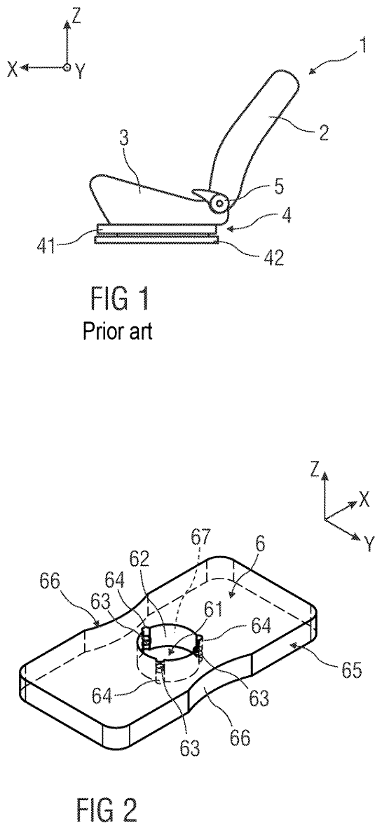

FIG. 1 shows a vehicle seat with a longitudinal adjustment device according to the prior art in a schematic diagram,

FIG. 2 schematically shows, in a perspective diagram, a first exemplary embodiment of a securing plate for a fastening device of a rail element of a longitudinal adjustment device,

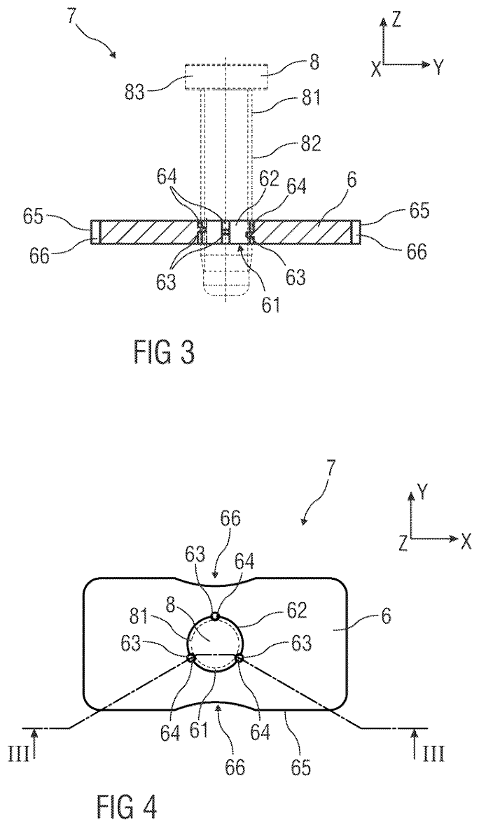

FIG. 3 schematically shows, in a side view, a first exemplary embodiment of a fastening device with a securing plate and a prefixed bolt,

FIG. 4 schematically shows a plan view of the securing plate according to FIG. 2,

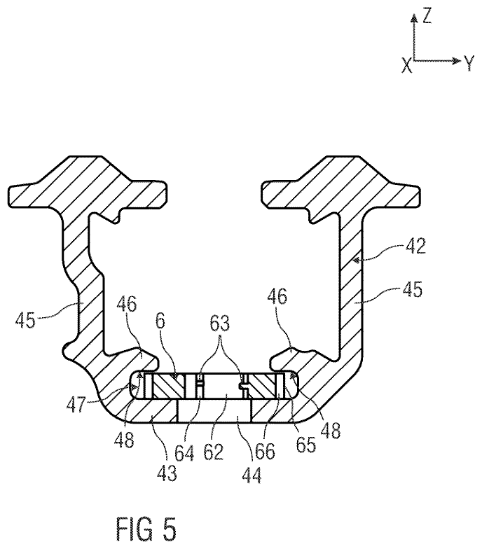

FIG. 5 schematically shows, in a sectional diagram, a first exemplary embodiment of a rail element with an inserted securing plate,

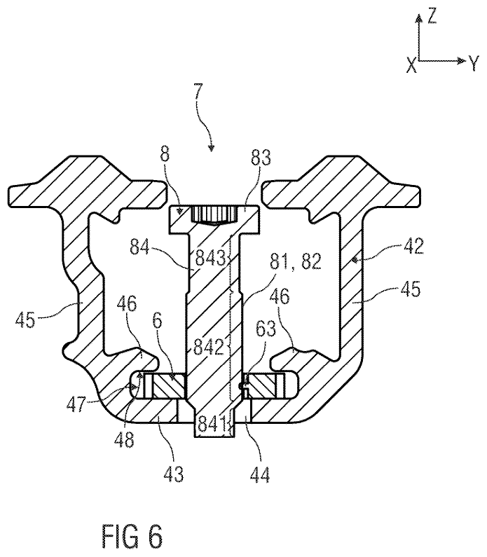

FIG. 6 schematically shows, in a sectional diagram, a first exemplary embodiment of the rail element with the inserted securing plate and with a bolt prefixed in the securing plate,

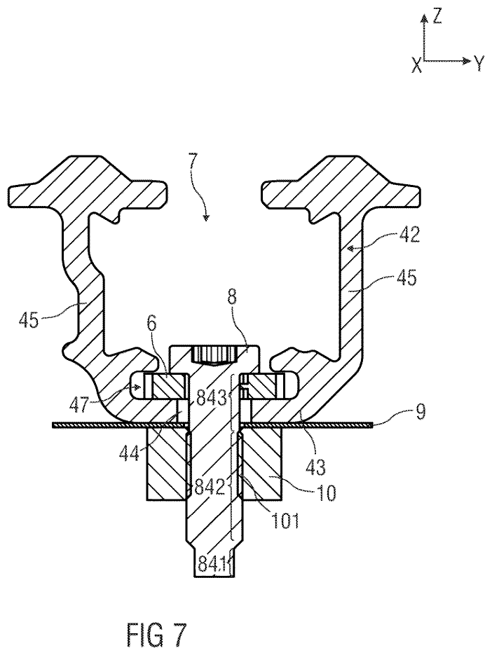

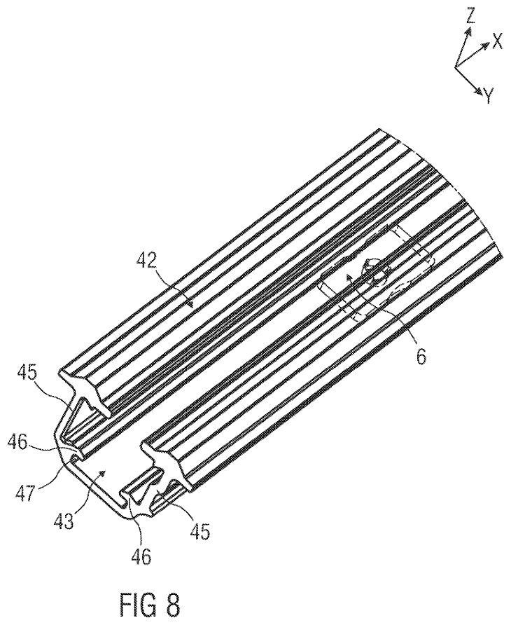

FIG. 7 schematically shows a sectional diagram of the first exemplary embodiment of the rail element with the inserted securing plate and in the assembled state with a structural element of a vehicle, wherein the bolt connects the rail element and the structural element to one another,

FIG. 8 schematically shows, in a perspective diagram, a rail element with an inserted securing plate,

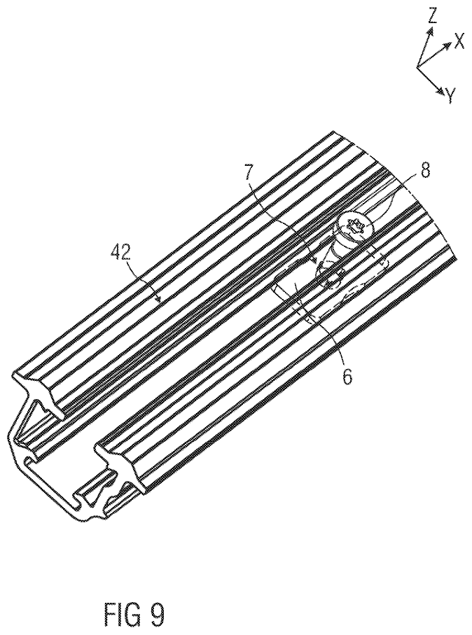

FIG. 9 schematically shows, in a perspective diagram, a rail element with an inserted securing plate and a prefixed bolt,

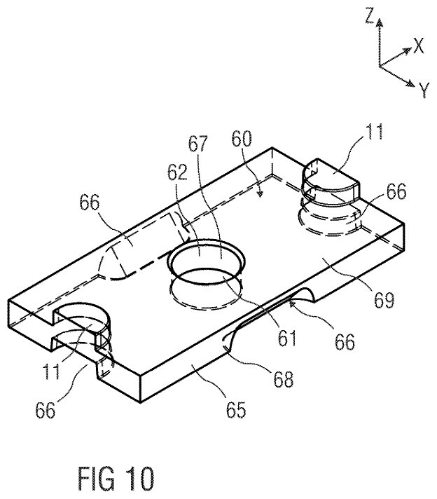

FIG. 10 schematically shows, in a perspective diagram, a second exemplary embodiment of a securing plate for a fastening device,

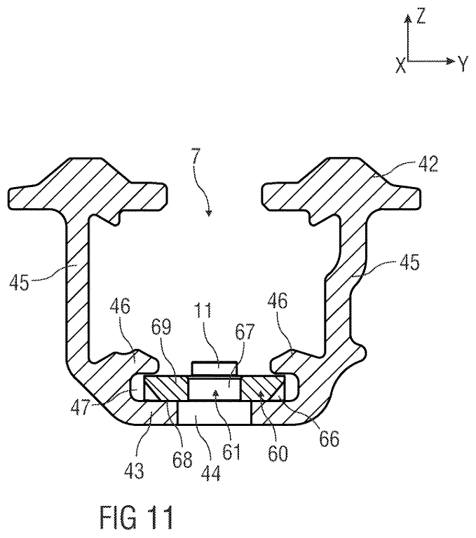

FIG. 11 schematically shows, in a side view, a second exemplary embodiment of a rail element with a fastening device with an inserted securing plate,

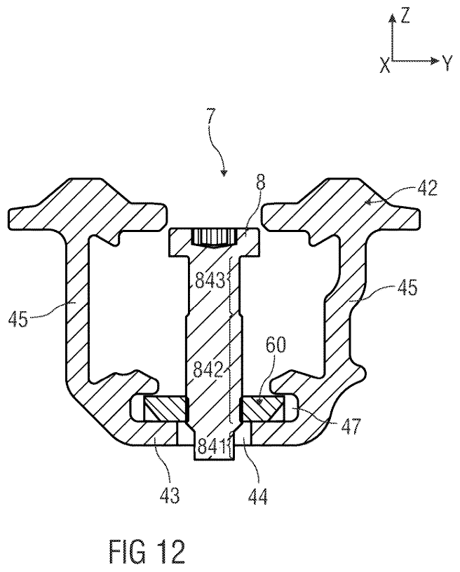

FIG. 12 schematically shows a sectional diagram of the second exemplary embodiment of the rail element with an inserted securing plate and with a bolt prefixed in the securing plate,

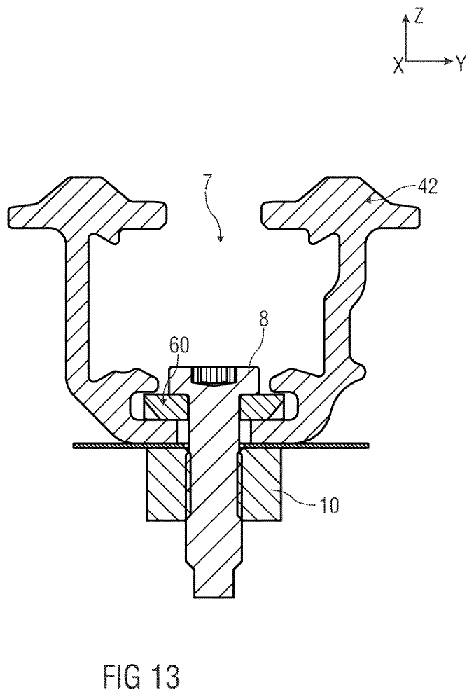

FIG. 13 schematically shows a sectional diagram of the second exemplary embodiment of the rail element with the inserted securing plate and in the assembled state with a structural element of a vehicle, wherein the bolt connects the rail element and the structural element to one another,

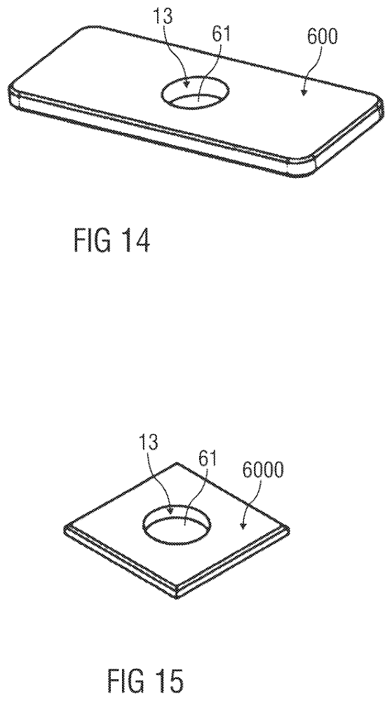

FIG. 14 schematically shows, in a perspective diagram, a first alternative form of a securing plate,

FIG. 15 schematically shows, in a perspective diagram, a second alternative form of a securing plate,

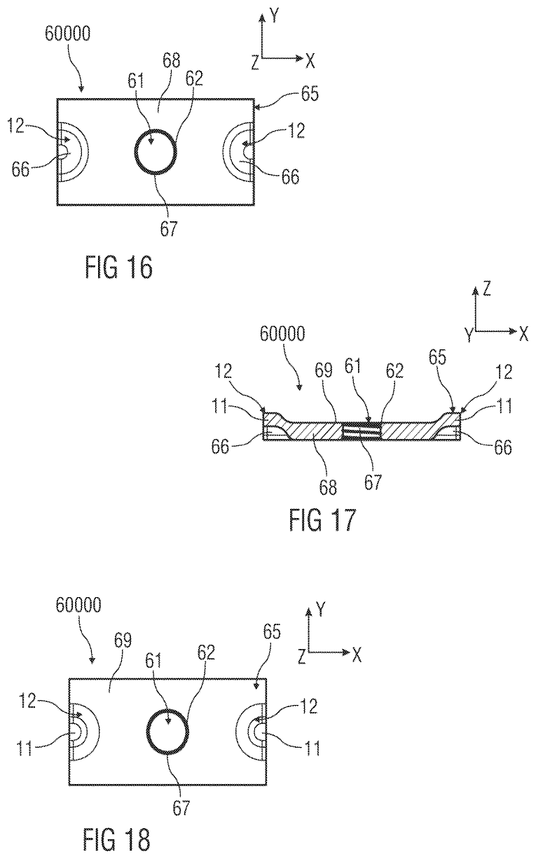

FIG. 16 schematically shows, in a view from below, a third alternative form of a securing plate,

FIG. 17 schematically shows, in a sectional diagram, the securing plate according to FIG. 16,

FIG. 18 schematically shows, in a plan view, the securing plate according to FIG. 16, and

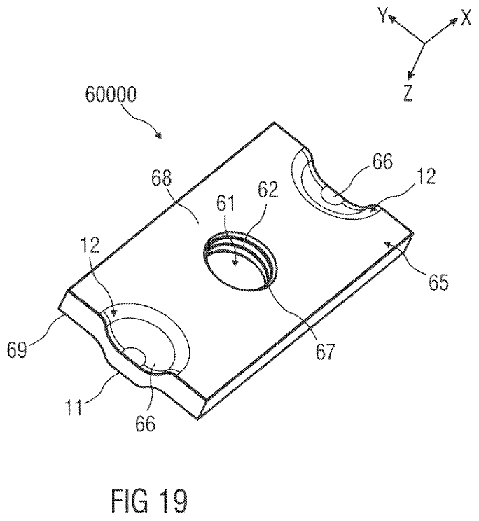

FIG. 19 schematically shows, in a perspective diagram, the securing plate according to FIG. 16.

Parts that correspond to one another are provided with the same reference signs in all the figures.

A vehicle seat 1 shown schematically in FIG. 1 for the prior art is described below using three spatial directions running perpendicularly to one another. When a vehicle seat 1 is installed in the vehicle, a longitudinal direction X runs largely horizontally and preferably parallel to a vehicle longitudinal direction, which corresponds to the usual direction of travel of the vehicle. A transverse direction Y running perpendicularly to the longitudinal direction X is likewise oriented horizontally in the vehicle and runs parallel to a vehicle transverse direction. A vertical direction Z runs perpendicularly to the longitudinal direction X and perpendicularly to the transverse direction Y. When a vehicle seat 1 is installed in the vehicle, the vertical direction Z preferably runs parallel to a vehicle vertical axis.

The position information and direction information used, such as front, rear, top and bottom, relate to a viewing direction of an occupant sitting in the vehicle seat 1 in a normal sitting position, wherein the vehicle seat 1 is installed in the vehicle in a use position suitable for conveying passengers, with an upright backrest 2 and oriented as usual in the direction of travel.

The vehicle seat 1 can however also be installed or moved in a different orientation, for example transversely to the direction of travel.

The backrest 2 can be arranged pivotably on a seat part 3 of the vehicle seat 1. For this purpose, the vehicle seat 1 can comprise a fitting 5, in particular a rotary fitting, such as a snap fitting or toggle fitting.

The vehicle seat 1 can comprise a longitudinal adjustment device 4, in particular a rail arrangement with a first rail element 41 and a second rail element 42. The first rail element 41 is adjustable in the longitudinal direction X relative to the second rail element 42. The first rail element 41 is fastened to the seat part 3. The second rail element 42 is fastened to a structural element 9 of a vehicle, for example a vehicle floor.

FIG. 2 schematically shows, in a perspective diagram, a first exemplary embodiment of a securing plate 6 for a fastening device 7 (shown in FIG. 3). By means of the fastening device 7, the second rail element 42 can be fastened to a structural element 9 (shown in FIG. 7), such as a vehicle floor of a vehicle.

The fastening device 7 comprises at least the one securing plate 6 and a bolt 8, which is shown in FIGS. 3, 6, 7, 9, 12 and 13.

The securing plate 6 comprises a through-opening 61. The securing plate 6 comprises a plurality of noses 6 , in particular three or more noses 63, to prefix the bolt 8 by means of self-locking for example on an inner circumference 62 of the through-opening 61. The noses 63 are arranged with a height offset from one another in the vertical direction Z. In particular, the noses 63 are molded, in particular stamped, on the inner circumference 62. For example, the noses 63 can be arranged in notches 64, in particular elongate depressions. In this case, the noses 63 have dimensions and/or a shape such that they protrude beyond the inner circumference 62 partially into the through-opening 61.

The noses 63 can be arranged distributed symmetrically around the inner circumference 62. For axially symmetrical prefixing of the bolt 8 in the securing plate 6, there are preferably three noses 63 provided, distributed symmetrically around the inner circumference 62 of the through-opening 61. This prefixing of the bolt 8 in the securing plate 6 with three symmetrically distributed noses 63 is also referred to as a three-point position of the bolt 8 in the securing plate 6.

The securing plate 6 can additionally comprise at least one recess 66, in particular two recesses 66, on the outer perimeter 65. The recesses 66 can be arcuate. Each recess 66 can also have another suitable shape, for example a polygonal shape. Each recess 66 on the outer perimeter 65 can be made for example by stamping into the outer contour of the securing plate 6.

The securing plate 6 has in particular a thickness or wall thickness of 3 mm to 5 mm, in particular of 4 mm to 4.5 mm, preferably of 4.5 mm.

The securing plate 6 has a large wall thickness and thus a high rigidity. This improves the force transmission from the screw or the bolt 8 (shown in FIG. 3) to the second rail element 42, in particular an aluminum profile of a lower rail. The problem can also arise here that there is a concentration of stress in the second rail element 42, in particular in the lower rail profile, directly laterally of a bolt head 83 (shown in FIG. 3). For this purpose, the securing plate 6 has the recesses 66, in particular a clearance, on the outer perimeter 65 in these regions to achieve an improvement in the distribution of stress in the second rail element 42, for example a lower rail profile.

The clearance or recess 66 can be implemented in various embodiment options. For example, the recess 66 can be punched into the outer contour of the securing plate 6. The recess 66 in question can be designed as an arc or can be angular. The recess 66 in question can alternatively be made by a stamp on the side facing the second rail element 42.

In a second exemplary embodiment, not shown in detail, the securing plate 6 has an internal thread 67 with an internal thread pitch instead of the noses 63 on the inner circumference 62 of the through-opening 61 to prefix the bolt 8 by means of self-locking. The bolt 8 has the at least one external thread 81 (shown in FIG. 3) with an external thread pitch. The internal thread pitch of the internal thread 67 in the through-opening 61 of the securing plate 6 differs from the external thread pitch of the external thread 81 of the bolt 8. In other words: In the assembled state, the bolt 8 is prefixed and held in the through-opening 61 of the securing plate 6 by the external thread 81 and the internal thread (not shown) by means of self-locking. For this purpose, the external thread pitch of the bolt 8 is different from the internal thread pitch in the through-opening 61 of the securing plate 6.

Because of the differing pitch of the external thread 81 of the bolt 8 and the internal thread 67 of the securing plate 6, self-locking of the bolt 8 occurs in the through-opening 61 of the securing plate 6.

The inner diameter of the through-opening 61 can also be designed such that the securing plate 6 comes out of engagement with the external thread 81 in the screwed-through region of the bolt 8. For this purpose, the bolt 8 has only a partial thread with for example M10 and a shank diameter of approximately 9 mm. The bore diameter of the through-opening 61 can be for example between 9.2 mm and 9.5 mm. The bolt 8 has at least one partial external thread. The partial external thread of the bolt 8 is necessary to ensure secure achievement of the fixed screw-fastening.

FIG. 3 schematically shows, in a side view, the first exemplary embodiment of the fastening device 7 with the securing plate 6 with three noses 63 in the through-opening 61 for self-locking prefixing of the bolt 8.

The securing plate 6 has a first strength, and the bolt 8 has a second strength. Preferably, the first strength of the securing plate 6 is lower than the second strength of the bolt 8. The lower first strength of the securing plate 6 in comparison with the second strength of the bolt 8 allows a deformation of the noses 63 without damage to or deformation of the bolt 8. The bolt 8 has at least one external thread 81 with multiple external thread flights 82.

During joining and in the assembled state, the noses 63 engage in the external thread flights 82 of the bolt 8. The bolt 8 is thereby prefixed and held by means of self-locking, in particular by means of a friction fit. The bolt 8 is held in position by the friction fit. In this case, the noses 63 have for example larger dimensions than those of the external thread flights 82 of the bolt 8.

The height offset of the noses 63 corresponds to the pitch of the external thread 81 of the bolt 8.

When the bolt 8 and securing plate 6 are joined, these noses 63 enter into a friction fit with the external thread flights 82 of the bolt 8 with interference.

Owing to the lower strength of the securing plate 6, deformation of the noses 63 occurs in the process, without damage to the bolt 8 in particular to the external thread 81. For example, the surfaces of the noses 63 are smoothed. In particular, the interference of the noses 63 is reduced to an effective interference producing the friction fit. The interference, in particular a height, of the noses 63 is designed for example such that the noses 63 in the screwed-through region of the bolt 8 come out of engagement with the external thread 81. For this purpose, the screw or bolt 8 has for example only a partial external thread with for example M10 and a shank diameter of approximately 9 mm.

In other words: Owing to the interference of the noses 63, plasticization and a friction fit connection between the bolt 8 and the securing plate 6 occur when the securing plate 6 and the bolt 8 are joined.

FIG. 4 schematically shows a plan view of the fastening device 7 with a securing plate 6 according to FIG. 2 with the lateral recesses 66 in the form of inward curves in the outer perimeter 65 and the noses 63 in the inner circumference 62 and the bolt 8 according to FIG. 3 prefixed on the noses 63 by means of self-locking.

FIG. 5 schematically shows a sectional diagram of a first exemplary embodiment of a second rail element 42, in particular a lower rail profile, of the longitudinal adjustment device 4 with a securing plate 6 inserted into the second rail element 42.

The second rail element 42 has a bottom region 43 with at least one mounting opening 44, in particular a through-bore. Two side walls 45 protrude perpendicularly from the bottom region 43. The second rail element 42 also comprises one or more guide tracks 46 arranged on the inside of the side walls 45. The guide tracks 46 are used for example as rolling faces or sliding faces for rollers or sliding elements of the first rail element 41.

The above-described fastening device 7 is arrangeable, in particular insertable, in the second rail element 42. In particular, the securing plate 6 is inserted into a guide channel 47, which is formed between an underside 48 of the guide tracks 46 and the bottom region 43, and is arranged longitudinally movably, in particular movably in the longitudinal direction X relative to the second rail element 42, in this guide channel 47. The guide channel 47 and the guide tracks 46 can extend in particular over the entire length of the second rail element 42.

The securing plate 6 is inserted into the guide channel 47 and positioned such that it lies with its through-opening 61 over the mounting opening 44. The second rail element 42 can have one or more, in particular two or three, mounting openings 44. Corresponding to the number of mounting openings 44, a corresponding number of securing plates 6 is insertable into the second rail element 42, in particular into the guide channel 47, and in each case one of the securing plates 6 is positionable over one of the mounting openings 44. In other words: The securing plates 6 are positionable variably in the second rail element 42.

FIG. 6 schematically shows a sectional diagram of the first exemplary embodiment of the second rail element 42 with an inserted securing plate 6 and with a bolt 8 prefixed in the securing plate 6.

The bolt 8 is inserted between the side walls 45 into the through-opening 61 of the securing plate 6. The bolt 8 comprises the bolt head 83 and a shank 84. The shank 84 has an insertion region 841, a partial thread region 842, and a thread-free region 843. The external thread 81 extends over the partial thread region 842. The insertion region 841 and the thread-free region 843 have outer dimensions that are smaller than the outer dimensions of the partial thread region 842.

The insertion region 841 can likewise be thread-free and is used for the secure, in particular tilt-free, insertion of the bolt 8 into the securing plate 6 and then into the mounting opening 44.

The bolt 8, in particular the partial thread region 842 thereof, enters into self-locking engagement, in particular a friction fit, with the noses 63 in the through-opening 61 when joined with the securing plate 6. The bolt 8 is thereby prefixed and held in the securing plate 6. Thanks to this prefastening of the bolt 8, in particular a screw, by means of self-locking in the securing plate 6, no further prefastening of the securing plate 6 is necessary. The securing plate 6 can be brought into position and held in the second rail element 42 with or without a prefixed bolt 8.

Preferably, the bolt 8 passes through the securing plate 6 with its insertion region 841 so that at least the insertion region 841 protrudes into the mounting opening 44 of the second rail element 42 or alternatively protrudes through the mounting opening 44.

FIG. 7 schematically shows a sectional diagram of the first exemplary embodiment of the rail element 42 with an inserted securing plate 6 and in the assembled final state with a structural element 9, in particular a vehicle floor of a vehicle.

By means of the fastening device 7, the second rail element 42 and the structural element 9 are connected to one another. The securing plate 6 is formed for example from a strong material, in particular from S700MC material. The securing plate 6 has a wall thickness or thickness in the mm range, in particular of 3 mm to 6 mm, for example of 4 mm to 5 m, preferably of 4.5 mm. This material with such a wall thickness has good strength with low material costs and does not need any heat treatment. The rigidity is also increased by the greater wall thickness of the securing plate 6. This in turn improves a force transmission in the assembled state from the bolt 8 to the second rail element 42, for example an aluminum profile of a lower rail.

For sufficiently firm connection of the second rail element 42 and the structural element 9, a fastening element 10, in particular a nut, is arranged on a surface side of the structural element 9 facing away from the rail element 42.

In the assembled final state, the external thread 81 of the bolt 8 engages connectingly in a nut internal thread 101 of the fastening element 10. The bolt 8 is inserted into the fastening element 10 such that the thread-free region 843 is arranged in the region of the through-opening 61 of the securing plate 6. The bolt 8, in particular the partial thread region 842 thereof, and the securing plate 6, in particular the noses 63 thereof, are thus out of engagement.

When the bolt 8 is joined into the fastening element 10, the self-locking prefixing of the bolt 8 in the securing plate 6 is overcome. For this purpose, the securing plate 6 is arranged and held at least non-rotatably and axially immovably in the guide channel 47.

FIG. 8 schematically shows, in a perspective diagram, a second rail element 42, in particular a lower rail, with an inserted securing plate 6 that is arrangeable in a longitudinally movable manner. The securing plate 6 is inserted in the guide channel 47 and has dimensions such that edge regions of the securing plate 6 are arranged under the underside 48 of the guide tracks 46. The securing plate 6 is thereby secured against falling out in the vertical direction Z. The securing plate 6 has a rectangular shape. In particular, the securing plate 6 has outer dimensions such that it is arranged non-rotatably in the guide channel 47, at least is arranged non-rotatably with respect to a rotation of more than 90°.

FIG. 9 schematically shows, in a perspective diagram, the second rail element 42 with the fastening device 7 with an inserted securing plate 6 and a prefixed bolt 8.

FIG. 10 schematically shows, in a perspective diagram, a second exemplary embodiment of a securing plate 60 for the fastening device 7.

Instead of the arcuate recess 66 of the securing plate 6, the recess 66 is angular. To avoid incorrect installation of the securing plate 60 in the second rail element 42, the securing plate 60 can additionally have direction elements 11, in particular direction noses. As a result, the securing plate 60 cannot be inserted the wrong way round into the guide channel 47. The direction element 11 is arranged on a side opposite the recess 66. For example, the direction element 11 is made in the securing plate 60 by stamping and/or punching. In the process, the securing plate 60 can be deformed in the vertical direction such that a recess 66 is produced on a first surface side 68, and a direction element 11 is produced on a second surface side 69 opposite the first surface side 68.

The above-described noses 63 or the above-described internal thread (not shown) can be provided on the inner circumference 62 of the through-opening 61 for self-locking prefixing of the bolt 8.

FIG. 11 schematically shows, in a side view, the second exemplary embodiment of the securing plate 60 according to FIG. 10 in the state inserted into the second rail element 42, in particular into the guide channel 47.

FIG. 12 schematically shows a sectional diagram of the second exemplary embodiment of the securing plate 60 with a bolt 8 prefixed therein. The same bolt 8 as described above can be used and held prefixably in an analogous manner in the securing plate 60 by means of self-locking, for example, by noses 63 or by an internal thread 67.

FIG. 13 schematically shows a sectional diagram of the second exemplary embodiment of the securing plate 60 in the assembled final state of the second rail element 42 with the structural element 9 by means of the fastening device 7, which connects them to one another as described above.

FIG. 14 schematically shows, in a perspective diagram, an alternative form of a securing plate 600 with a through-opening 61 for the self-locking prefixing of the bolt 8 and without a recess 66 and without a direction element 11. To prefasten the bolt 8, the securing plate 600 can have a ring 13 in the through-opening 61. The ring 13 can be an O-ring, for example.

The ring 13 can be a sealing ring. The ring 13 can be arranged at at least one axial end of the through-opening 61 or of the securing plate 600. At least some portions of the ring 13 can extend axially over the through-opening 61. The inner circumference 62 of the through-opening 61 can be provided with the ring 13. The ring 13 can be connected to the inner circumference 62 force-fittingly, form-fittingly and/or by a material bond, for example. A height of the ring 13 can be formed to correspond to the wall thickness of the securing plate 600. A material bond between the inner circumference 62 of the through-opening 61 and the ring 13 can be brought about by vulcanizing the ring 13 at least partially or in some portions into the through-opening 61. The ring 13 can be formed from a rubber material, for example. The ring 13 can be formed from ethylene-propylene-diene rubber. A thread can be made on the inner circumference of the ring 13. The thread, for example internal thread, of the ring 13 can be designed to correspond to the external thread 81 of the bolt 8.

FIG. 15 schematically shows, in a perspective diagram, a further alternative form of a securing plate 6000 with a through-opening 61 for the self-locking prefixing of the bolt 8 and without a recess 66 and without a direction element 11. To prefasten the bolt 8, the securing plate 6000 can have a ring 13 in the through-opening 61. The ring 13 can be an O-ring, for example. The ring 13 can be a sealing ring. The ring 13 can be arranged at at least one axial end of the through-opening 61 or of the securing plate 6000. The inner circumference 62 of the through-opening 61 can be provided with the ring 13. The ring 13 can be connected to the inner circumference 62 force-fittingly, form-fittingly and/or by a material bond, for example. A height of the ring 13 can be formed to correspond to the wall thickness of the securing plate 6000. At least some portions of the ring 13 can extend axially over the through-opening 61. A material bond between the inner circumference 62 of the through-opening 61 and the ring 13 can be brought about by vulcanizing the ring 13 at least partially or in some portions into the through-opening 61. The ring 13 can be formed from a rubber material, for example. The ring 13 can be formed from ethylene-propylene-diene rubber. A thread can be made on the inner circumference of the ring 13. The thread, for example internal thread, of the ring 13 can correspond with the external thread 81 of the bolt 8.

FIG. 16 schematically shows, in a view from below, a further alternative form of a securing plate 60000. FIG. 17 schematically shows the securing plate 60000 in a sectional diagram, FIG. 18 schematically shows the securing plate 60000 in a plan view, and FIG. 19 schematically shows the securing plate 60000 in a perspective diagram.

The securing plate 60000 comprises a through-opening 61. The securing plate 60000 has a first strength, and the bolt 8 has a second strength. For example, the first strength is lower than the second strength.

The securing plate 60000 has an internal thread 67 with an internal thread pitch on the inner circumference 62 of the through-opening 61 for prefixing the bolt 8 by means of self-locking. The bolt 8 has the at least one external thread 81 with an external thread pitch. The internal thread pitch of the internal thread 67 in the through-opening 61 of the securing plate 60000 differs from the external thread pitch of the external thread 81 of the bolt 8. In other words: In the assembled state, the bolt 8 is prefixed and held in the through-opening 61 of the securing plate 60000 by the external thread 81 and the internal thread 67 by means of self-locking. For this purpose, the external thread pitch of the bolt 8 is different from the internal thread pitch in the through-opening 61 of the securing plate 60000. Alternatively, the through-opening 61 can also be provided with an above-described ring 13 for prefixing the bolt 8 in the through-opening 61. Alternatively, the through-opening 61 and the internal thread 67 thereof can be coated with a rubber material.

Because of the differing pitch of the external thread 81 of the bolt 8 and the internal thread 67 of the securing plate 60000, self-locking of the bolt 8 occurs in the through-opening 61 of the securing plate 60000.

The inner diameter of the through-opening 61 can also be designed such that the securing plate 60000 comes out of engagement with the external thread 81 in the screwed-through region of the bolt 8. For this purpose, the bolt 8 has only a partial thread with for example M10 and a shank diameter of approximately 9 mm. The bore diameter of the through-opening 61 can be for example between 9.0 mm and 9.7 mm. The through-opening 61 can for example be designed as an M10×1.45 thread for clamping the bolt 8. In this case, a bore diameter, in particular an inner diameter of the through-opening 61, can be 9.5 mm so that a core diameter of the bolt 8 does not clamp. The bolt 8 has at least one partial external thread. The partial external thread of the bolt 8 is necessary to ensure secure achievement of the fixed screw-fastening.

The securing plate 60000 has two opposing recesses 66 on the outer perimeter 65. The recesses 66 are arcuate. Each recess 66 can also have another suitable shape, for example a polygonal shape. Each recess 66 on the outer perimeter 65 can be made for example by stamping into the outer contour of the securing plate 60000. The securing plate 60000 is deformed at the end and/or on the outer perimeter 65 by means of a stamping method and/or punching method, for example. The recesses 66 are made in the securing plate 60000 as deformation regions 12. This allows a simple and cost-effective production method with only a few production steps. The formation of each recess 66 and each direction element 11 in the form of a nose or a protrusion takes place simultaneously.

A predefined region of the securing plate 60000 is deformed in a vertical direction by stamping or punching such that a recess 66 is produced on a first surface side 68, and a direction element 11 is produced on a second surface side 69 opposite the first surface side 68.

Each deformation region 12 of the securing plate 60000 thus has a recess 66 and a direction element 11. The deformation regions 12 are arcuate and/or semicircular. A diameter of each deformation region 12 is for example between 8 mm and 17 mm, for example 15 mm.

The deformation regions 12 are for example substantially conical, funnel-shaped or cylindrical.

The securing plate 60000 has in particular a thickness or wall thickness of 3 mm to 5 mm, in particular of 4 mm to 4.5 mm, preferably of 4.5 mm.

The securing plate 60000 has a large wall thickness and thus a high rigidity. This improves the force transmission from the screw or the bolt 8 to the second rail element 42, in particular an aluminum profile of a lower rail. The problem can also arise here that there is a concentration of stress in the second rail element 42, in particular in the lower rail profile, directly laterally of a bolt head 83. For this purpose, the securing plate 60000 has the recesses 66, in particular a clearance, on the outer perimeter 65 in these regions to achieve an improvement in the distribution of stress in the second rail element 42, for example a lower rail profile.

To avoid incorrect installation of the securing plate 60000 in the second rail element 42, the securing plate 60000 has the relevant direction element 11, in particular direction nose or direction protrusion. As a result, the securing plate 60000 cannot be inserted the wrong way round into the guide channel 47. The direction element 11 protrudes from the surface side 69 of the securing plate 60000. The relevant recess 66 on the first surface side 68 accordingly forms the direction element 11 on the second surface side 69. In the assembled state, the first surface side 68 of the securing plate 60000 faces the bottom region 43 of the second rail element 42. The second surface side 69 is directed into a profile space of the second rail element 42.

### LIST OF REFERENCE SIGNS

1 Vehicle seat
2 Backrest
3 Seat part
4 Longitudinal adjustment device
41 First rail element
42 Second rail element
43 Bottom region
44 Mounting opening
45 Side wall
46 Guide track
47 Guide channel
48 Underside of guide track
5 Fitting
6, 60, 600, 6000, 60000 Securing plate
61 Through-opening
62 Inner circumference
63 Nose
64 Notch
65 Outer perimeter
66 Recess
67 Internal thread
68, 69 Surface side
7 Fastening device
8 Bolt
81 External thread
82 External thread flights
83 Bolt head
84 Shank
841 Insertion region
842 Partial thread region
9 Structural element
10 Fastening element
101 Nut internal thread
11 Direction element
12 Deformation region
13 Ring
X Longitudinal direction
Y Transverse direction
Z Vertical direction

1-15. (canceled)

16. A fastening device for a rail element of a longitudinal adjustment device, comprising at least one securing plate with a through-opening and a bolt with at least one external thread, wherein the bolt is prefixed and held in the through-opening by self-locking, and wherein the securing plate has a first strength and the bolt has a second strength.

17. The fastening device as claimed in claim 16, wherein the first strength is lower than the second strength.

18. The fastening device as claimed in claim 16, wherein the securing plate has a number of noses on an inner circumference of the through-opening to prefix the bolt.

19. The fastening device as claimed in claim 18, wherein at least two noses are provided, which are molded with a height offset from one another on the inner circumference of the through-opening.

20. The fastening device as claimed in claim 18, wherein, in the assembled state, the noses are arranged to engage in external thread flights of the bolt.

21. The fastening device as claimed in claim 16, wherein the through-opening of the securing plate is provided with a ring.

22. The fastening device as claimed in claim 21, wherein the ring is provided to enter into self-locking engagement with the bolt when the bolt is joined with the securing plate.

23. The fastening device as claimed in claim 21, wherein the ring is a sealing element.

24. The fastening device as claimed in claim 21 wherein the ring is connected to the through-opening at least by a material bond.

25. The fastening device as claimed in claim 21, wherein the ring is vulcanized into the through-opening.

26. The fastening device as claimed in claim 16, wherein the securing plate has an internal thread with an internal thread pitch on an inner circumference of the through-opening to prefix the bolt, wherein the internal thread pitch of the through-opening is different from an external thread pitch of the bolt.

27. The fastening device as claimed in claim 16, wherein the securing plate comprises at least one recess, which is arcuate or angular, on the outer perimeter.

28. The fastening device as claimed in claim 16, wherein the securing plate has at least one direction element, which protrudes from a surface side of the securing plate.

29. A rail element for a longitudinal adjustment device, comprising a bottom region that is connectable to a structural element of a vehicle and has at least one mounting opening and two side walls protruding from the bottom region, and the fastening device as claimed in claim 16, wherein the fastening device is arranged between the side walls and on the bottom region such that the securing plate lies with its through-opening over the mounting opening of the rail element.

30. The rail element as claimed in claim 29, wherein the bolt is guided through the through-opening of the securing plate and is arranged engaging partially into the mounting opening of the rail element.
